(19) United States
(12) Patent Application Publication
(10) Pub. No.: US 2012/0139164 A1
(43) Pub. Date: Jun. 7, 2012

(54) POWDER COMPACTING DEVICE AND METHOD FOR MANUFACTURING SOLID POWDER COMPACT

(75) Inventors: Takao Ishikawa, Tokyo (JP); Ikuo Fukuda, Tokyo (JP)

(73) Assignee: KAO CORPORATION, Tokyo (JP)

(21) Appl. No.: 13/060,913

(22) PCT Filed: Aug. 28, 2009
(86) PCT No.: PCT/JP2009/065095

§ 371 Date: Mar. 21, 2011

(30) Foreign Application Priority Data
Aug. 28, 2008 (JP) 2008-218930
Aug. 28, 2008 (JP) 2008-220361

(51) Int. Cl. B28B 1/08; B30B 11/00

(52) U.S. Cl. 264/442; 425/174.2

(57) ABSTRACT

A compacting device of the invention includes: a die (11) having a through hole (10) extending in a vertical direction; and a container support (12) inserted into the through hole (10) vertically from below, disposed to be vertically movable in the through hole (10), and supporting a container (3) from below while being in contact with a portion of a lower surface of the container (3). The container support (12) and the through hole (10) define a housing space (S) for the container (3). The compacting device further includes: a lower punch (20a) for applying ultrasonic vibration to powder contained in the container (3); and an upper punch (20b). The container support (12) has a movement path (15) for the lower punch (20a), formed along the entire vertical length of the container support (12). The lower punch (20a) is provided in such a manner that it can move through the movement path (15) and come into contact with portions of the lower surface of the container (3) other than the above-described portion thereof.

### TECHNICAL FIELD

The present invention relates to a powder compacting device for compacting powder, such as powder cosmetic materials, contained in a container while applying ultrasonic vibration to the powder, and a method for manufacturing a solid powder compact using the compacting device.

### BACKGROUND ART

Press-compacting, one of various known powder compacting methods, involves filling powder into e.g. a predetermined container and pressing and compacting the powder. In press-compacting, compression of powder allows the powder's own cohesive force and/or the binding effect of a binder, such as an oil-based substance contained in the powder, to be exerted, which thus solidifies and compacts the powder. Press-compacting, however, sometimes finds difficulty in solidifying and compacting powder, depending on the physical properties and/or the shape/form of the powder itself or the composition of components in cases where several types of powders are used in combination.

One way of overcoming such drawbacks of press-compacting is to apply ultrasonic vibration to the powder in addition to pressing. Patent Literature 1, for example, discloses the use of a compacting device including a table having a vertically-extending through hole, an upper punch inserted into the through hole vertically from above, and a lower punch inserted into the through hole vertically from below, to perform a tablet-manufacturing method including the steps of: filling a powder material into a depression defined by the through hole and the upper surface of the lower punch, inserting the lower surface of the upper punch into the depression, and compacting the powder material while applying ultrasonic vibration both from above and below the powder material, thereby producing a tablet. Patent Literature 1 alleges that, according to the disclosed method, the use of ultrasonic vibration allows production of high-quality compacts having uniform density and hardly any defects, regardless of the type of powder used.

Patent Literature 2 discloses a fully-automatic compacting device for press-compacting cosmetic materials in the form of powder, etc., including a turntable having a plurality of powder compressing spaces, and a set of vertically-paired compressing means for compressing the powder contained in each compressing space from above and below. The compacting device successively places containers into the respective compressing spaces, fills powder into each container, and then presses and compacts the powder, together with the container, using the compressing means. The compacting device of Patent Literature 2 further includes a vertically-movable pressing element 27 (see, for example, FIG. 2 of Patent Literature 2) which serves as a container support for supporting the powder-containing container from below within the compressing space. Because of such a configuration, the upward powder compression by the compressing means from below is performed indirectly via the pressing element 27. Patent Literature 2 alleges that the disclosed compacting device can continuously manufacture a multitude of compacts and can also perform optimal compacting in conformity with the various types of cosmetic materials extremely easily and with a high degree of freedom.

### CITATION LIST

### Patent Literature

Patent Literature 1: JP-A-2007-210985
Patent Literature 2: JP-A-63-60913

### SUMMARY OF INVENTION

### Technical Problem

The compacting device of Patent Literature 1 uses no container for containing the powder at the time of compacting, and thus, the powder is directly supplied onto the upper surface of the lower punch which defines the depression. Therefore, it is necessary to completely remove the powder remaining inside the depression after the predetermined compacting process. Such a task impedes continuous manufacturing of a multitude of compacts, thus impairing productivity. Further, the compacting device of Patent Literature 1 is difficult to use when compacting powder in a container, i.e., when manufacturing a compact contained in a container.

Meanwhile, in continuous compact manufacturing devices such as the compacting device disclosed in Patent Literature 2, variations etc. in quality and properties (e.g., bulk density) of the powder, which serves as the material for the compacts, may cause variations and/or reduction in the quality of the compacts produced. Such problems caused by powder in continuous compact manufacturing devices can effectively be solved by adjusting the amount of powder filled into the container depending on any type of powder. From this standpoint, it is preferable that such a continuous compact manufacturing device, which compacts powder in a container, has a mechanism for adjusting the powder fill amount. In the compacting device of Patent Literature 2, the pressing element 27, which serves as a container support defining the bottom of the compressing space onto which a container is placed, is disposed so that it can be moved vertically. It is thus considered that vertical movement of the pressing element 27 at the time of filling the powder into a container placed in the compressing space depending on any type of powder allows the capacity of the compressing space to be adjusted, which, in turn, allows adjustment of the amount of powder filled into the container.

However, when an attempt is made in the compacting device of Patent Literature 2 to apply ultrasonic vibration from below the container to the powder contained therein as in Patent Literature 1 with the aim of producing compacts with higher quality, the pressing element 27, located directly below the container and serving as a container support, impedes transmission of ultrasonic vibration to the powder inside the container, thus preventing the effect of ultrasonic vibration from being exerted. There has yet to be provided a powder compacting device that can manufacture compacts continuously, that can adjust the powder fill amount depending on any type of powder, and that can produce high-quality compacts, regardless of any type of powder, through powder-compacting utilizing ultrasonic vibration.

Accordingly, the present invention relates to the provision of a powder compacting device capable of performing compacting that suits any type of powder and also capable of stably and efficiently providing high-quality compacts, and to the provision of a method for manufacturing solid powder compacts using the compacting device.

### Solution to Problem

The invention relates to a powder compacting device for compacting powder contained in a tray-like container while applying ultrasonic vibration to the powder, including: a die having a through hole extending in a vertical direction; and a container support inserted into the through hole vertically from below, disposed to be vertically movable in the through hole, and supporting the container from below while being in contact with a portion of a lower surface of the container. The container support and the through hole define a housing space for the container. The device further includes a lower punch for applying ultrasonic vibration to the powder in the container, the lower punch being disposed to be vertically movable below the container supported by the container support; and an upper punch disposed to be vertically movable in a position opposing the lower punch across the container. The upper punch and the lower punch are capable of compressing the powder together with the container. The container support has a movement path for the lower punch to move in, formed along the entire vertical length of the container support. The lower punch is provided in such a manner that it can move through the movement path and come into contact with portions of the lower surface of the container other than the portion thereof contacted by the container support to support the container.

The invention also relates to a method for manufacturing a solid powder compact, including the use of the above-described powder compacting device.

### Advantageous Effects of Invention

The powder compacting device and the method for manufacturing solid powder compacts of the present invention make possible the compacting that suits any type of powder serving as the material for the compacts, and also make possible stable, efficient production of high-quality compacts having uniform density and hardly any defects, regardless of any type of powder.

### BRIEF DESCRIPTION OF DRAWINGS

FIG. 1 is a schematic top view illustrating the whole of a one embodiment of a powder compacting device of the invention.

FIG. 2 is a schematic diagram of primary parts (primary parts at the position of symbol D in FIG. 1) of the device illustrated in FIG. 1.

FIG. 3 is a schematic, vertical cross-sectional view of a die and a container support inserted into a through hole of the die of the device illustrated in FIG. 1.

FIG. 4 is a schematic top view of the die and the container support illustrated in FIG. 3.

FIG. 5 is a schematic perspective of the container support illustrated in FIG. 3.

FIG. 6 is a schematic perspective of a lower punch illustrated in FIG. 2.

FIG. 7 is a diagram illustrating the relationship between respective contour lines of the lower punch and an upper punch at confronting surfaces thereof when the upper punch and the lower punch illustrated in FIG. 2 are made to confront one another.

FIG. 8 is a schematic top view illustrating how capacity adjustment plates (lifting/lowering means) of the device of FIG. 1 are disposed.

FIG. 9 is a diagram illustrating steps of manufacturing a compact using the device of FIG. 1.

FIG. 10 is a schematic perspective of another embodiment of the container support according to the invention.

FIG. 11(a) and FIG. 11(b) respectively illustrate schematic perspective views of other embodiments of the container support of the invention, and FIG. 11(c) illustrates a schematic perspective of a lower punch used in combination with the container support of FIG. 11(a) or FIG. 11(b).

FIG. 12(a) is a schematic perspective of another embodiment of the container support according to the invention, and FIG. 12(b) is a schematic perspective of a lower punch used in combination with the container support of FIG. 12(a).

FIG. 13 is a perspective illustrating a compact (cheek rouge) produced in Examples.

### DESCRIPTION OF EMBODIMENTS

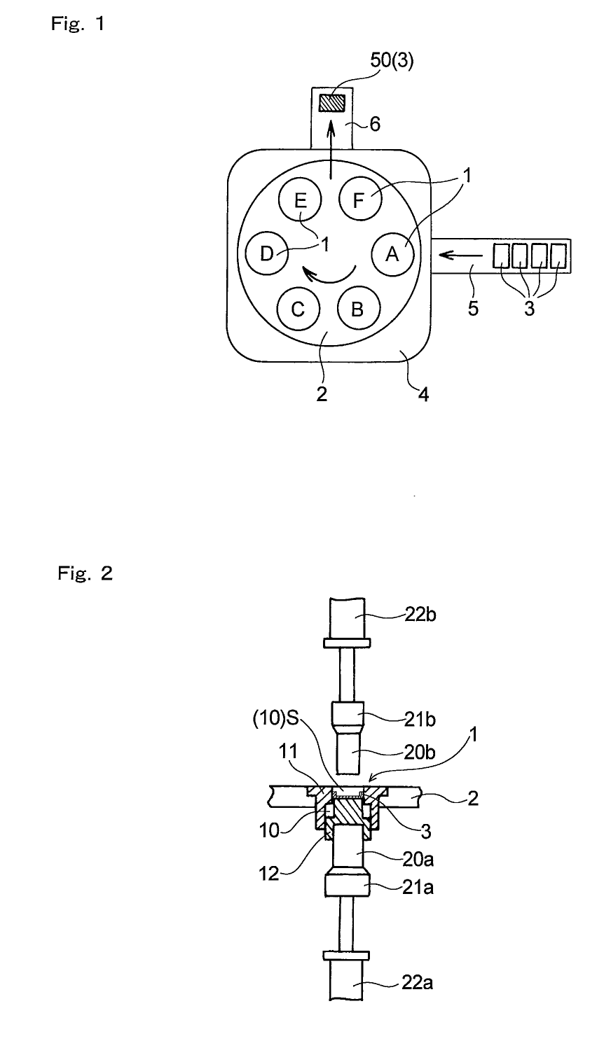

The present invention will be described below according to preferred embodiments thereof with reference to the drawings. FIG. 1 illustrates a schematic top view of the whole of a powder compacting device (also referred to hereinafter as “compacting device”) according to the present embodiment. The compacting device of the embodiment is a device for compacting powder contained in a tray-like container 3 while applying ultrasonic vibration to the powder, to manufacture a compact 50 contained in the container 3. The device includes a turntable 2 having a plurality of (or, six) sections (or, compacting sections) 1 for compacting powder, which is the material for the compact. The turntable 2 is turnable in its circumferential direction by a driving source (not illustrated). The compacting device of the embodiment turns the turntable 2 in its circumferential direction so that the compacting sections 1 successively pass the positions indicated by respective symbols A through F to undergo predetermined processes at those positions, allowing a plurality of compacts 50 to be manufactured continuously.

The compacting sections 1 are arranged at even intervals along the circumferential edge of the turntable 2, which is round in planar view. The turntable 2 is arranged on a base member 4 so that it is turnable in the direction of the arrow illustrated in FIG. 1 (i.e., clockwise). A conveyor 5 for conveying, to the turntable 2, empty containers 3 having no powder therein is connected to a position of the base member 4 indicated by symbol A in FIG. 1. A conveyor 6 for collecting the compacts 50, contained in respective containers 3, discharged from the turntable 2 is connected to a position of the base member 4 at the midpoint between symbols E and F illustrated in FIG. 1.

FIG. 2 schematically illustrates a vertical cross-sectional view of a compacting section 1 at the position of symbol D in FIG. 1. As will be described further below, in the compacting device of the present embodiment, the powder is compacted at the position of symbol D of FIG. 1. As illustrated in FIGS. 2 to 4, each compacting section 1 includes: a die 11 having a though hole 10 extending in a vertical direction; and a container support 12 inserted into the through hole 10 vertically from below, disposed to be vertically movable in the through hole 10, and supporting the container 3 from below while being in contact with a portion of a lower surface of the container 3. The through hole 10 and the container support 12 are capable of defining a housing space S for the container 3.

As illustrated in FIG. 2, the compacting device of the embodiment includes: a lower punch (lower hone) 20a for applying ultrasonic vibration to the powder in the container 3, the lower punch 20a being disposed to be vertically movable below the container 3 supported by the container support 12; and an upper punch (upper hone) 20b disposed to be vertically movable in a position opposing the lower punch 20a across the container 3. The lower punch 20a and the upper punch 20b are capable of compressing the powder together with the container 3. The lower punch 20a and the upper punch 20b are disposed at the position of symbol D of FIG. 1 so as to sandwich the compacting section 1 from below and above. The lower punch 20a and the upper punch 20b each consist of a rigid body, such as metal, having a shape insertable into the container 3 (i.e., a quadrangular prism having rounded corners in the present embodiment), and the cross-sectional shape of each punch taken along a direction orthogonal to its length direction is in similarity with the planar shape of the container 3 (i.e., the shape of the bottom plate of the container 3 in planar view). At the time of compacting the powder, the punches serve to apply ultrasonic vibration to the powder and also serve as compacting punches for compressing the powder.

The lower end of the lower punch 20a is provided with an ultrasonic vibration element 21a which is supported by an air cylinder 22a. The lower punch 20a, the ultrasonic vibration element 21a, and the air cylinder 22a are positioned coaxially. The air cylinder 22a is mounted on a support member (not illustrated). Such a structure allows vertical movement of the lower punch 20a and the ultrasonic vibration element 21a. Likewise, the upper end of the upper punch 20b is provided with an ultrasonic vibration element 21b which is supported by an air cylinder 22b. The upper punch 20b, the ultrasonic vibration element 21b, and the air cylinder 22b are positioned coaxially. The air cylinder 22b is mounted on a support member (not illustrated) and is suspended therefrom. Such a structure allows vertical movement of the upper punch 20b and the ultrasonic vibration element 21b. Note that the means for moving the ultrasonic vibration element is not limited to an air cylinder, and other devices may be used, such as a hydraulic cylinder or an electric-motor-driven ball screw press. Further, the means for moving the ultrasonic vibration element does not have to be positioned coaxially with the punch and the ultrasonic vibration element.

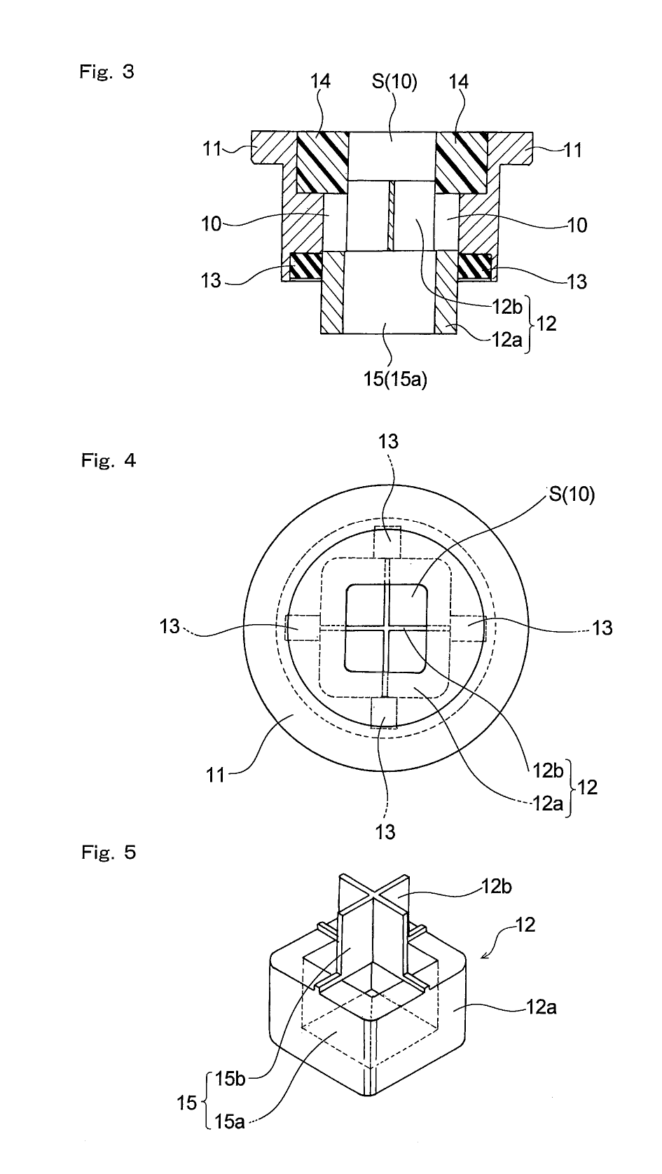

As illustrated in FIGS. 3 and 4, the die 11 consists of a substantially-cylindrical rigid body, such as metal, and has a round shape in planar view (i.e., as viewed from above). The upper end section of the die 11 is formed into a flange, the flange projecting outward in the horizontal direction and being bolted down (not illustrated) onto the turntable 2. The through hole 10 is formed in the die 11 in its center as regards the horizontal direction, which is orthogonal to the vertical direction, and has a quadrangular shape (square shape) with rounded corners as viewed from vertically above (i.e., in top view), as illustrated in FIG. 4. As illustrated in FIG. 3, the size of the opening of the through hole 10 changes at one point during the course of consecutively viewing the opening's vertical cross section from top to bottom, with the lower opening size being larger than the upper opening size.

The lower end section of the die 11 has positioning members 13, disposed so as to be exposed at the inner wall surface of the through hole 10, for positioning the container support 12. In the present embodiment, four positioning members 13 are arranged at even intervals along the inner wall surface of the through hole 10 as illustrated in FIG. 4, and these four positioning members 13 allow the container support 12 to be fixed inside the through hole 10 at a desired position. More specifically, the frictional force of the positioning members 13 can effectively prevent the container support 12, which has been inserted into and fixed to the through hole 10, from falling under its own weight. Note that the container support 12 can still be made to slide vertically in the through hole 10 by, e.g., later-described container placement means 30 and post-compression section 7b, even in the presence of the positioning members 13. Examples of materials usable for the positioning members 13 include elastic elements or rubbers, such as urethane rubber, nitrile rubber, ethylene rubber, butyl rubber, fluorine-containing rubber, or silicone rubber, and sponges.

From the standpoint of lessening abrasion of the container 3 and the inner wall surface of the through hole 10 due to ultrasonic vibration, it is preferable that the inner wall surface of the through hole 10 defining the housing space S for the container 3 is formed containing resin; preferably, a portion of the die 11 is formed as a resinous section 14 consisting of resin, as illustrated in FIG. 3. This is described in further detail. In the present embodiment, ultrasonic vibration is applied to the powder in the container, which is housed in the housing space S, and this ultrasonic vibration causes the container to vibrate. Thus, the ultrasonic vibration may cause damage in the contacting sections of the wall surface and the container depending on the material properties of the inner wall surface of the through hole 10 which constitutes the housing space S. This not only creates abrasion marks in the contacting sections due to abrasion, but may also give rise to such problems as contamination and spoilage of appearance of the compact, due to abrasion debris. Therefore, in the present embodiment, it is preferable to form the inner wall surface of the through hole 10, which defines the housing space S for the container 3, using the resinous section 14 from the standpoint of eliminating the problems of abrasion caused by ultrasonic vibration. The container 3 is usually made of metal such as an aluminum alloy or a resin such as polyethylene terephthalate; so, from the standpoint of effectively reducing abrasion marks and abrasion debris, it is preferable that the material used for the inner wall surface of the through hole 10 is a resin having a hardness equal to or less than that of the material used for the container 3.

The resinous section 14 consists substantially of resin. It is possible to use at least one of, for example, polyacetal, “MC Nylon” (registered trademark), rigid polyethylene, or fluorocarbon resin, as the resin. Among the above, polyacetal is suitably used in the present invention because of its excellent effect in reducing abrasion marks and abrasion debris.

The container support 12 is made of a rigid body, such as metal, and is shaped to match the shape of the through hole 10. As illustrated in FIG. 5, the container support 12 has a base section 12a having the shape of a quadrangular prism with rounded corners, and a supporting section 12b provided on the base section 12a for supporting from below the container housed in the housing space S. The upper end section of the supporting section 12b serves as the front-end side as regards the direction in which the container support 12 is inserted into the through hole 10, and also serves as a contacting section that comes in contact with the container; at the time of compacting, the container 3 for containing powder is placed on the upper end section of the supporting section 12b. The upper end section of the supporting section 12b (i.e., the contacting section of the container support 12 which is in contact with the container) is in the shape of a cross when viewing a horizontal cross-section thereof (a cross-section taken along a direction orthogonal to the vertical direction), as illustrated in FIG. 4.

As illustrated in FIG. 5, the container support 12 has a movement path 15 for the lower punch 20a to move in, the movement path 15 being formed along the entire vertical length of the container support 12. The movement path 15 consists of a through hole 15a opened vertically through the base section 12a of the container support 12; and a surrounding space 15b of the supporting section 12b, centered around the supporting section 12b which is provided on the base section 12a. The through hole 15a and the surrounding space 15b are positioned coaxially.

According to this structure, the lower punch 20a is provided in such a manner that it can move through the movement path 15 and come into contact with portions of the lower surface of the container 3 other than the portion thereof contacted by the container support 12 to support the container (i.e., other than the contacting section of the lower surface of the container 3 in contact with the container support 12).

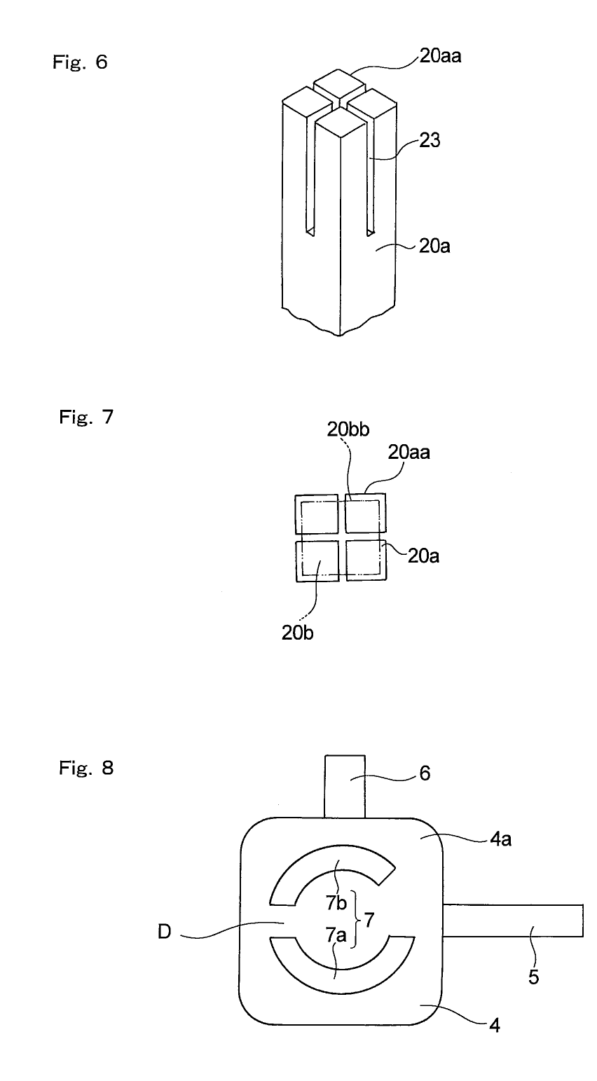

The lower punch 20a is shaped to match the shape of the movement path 15, and this movement path 15 allows the lower punch 20a to move along the entire vertical length of the container support 12. More specifically, as illustrated in FIG. 6, the lower punch 20a is shaped like a quadrangular prism, and its upper end section (i.e., the front-end section as regards the direction in which the lower punch 20a is inserted into the movement path 15) has cuts 23 of a predetermined length opened from the upper end and extending along the length direction of the lower punch 20a. These cuts 23 serve as gaps into which the supporting section 12b of the container support 12 is inserted as the lower punch 20a moves through the movement path 15, and are formed in a shape corresponding to the horizontal cross-sectional shape of the upper end section of the supporting section 12b, i.e., formed in the shape of a cross, when viewing a horizontal cross-section of the lower punch 20a (i.e., when viewing a cross-section taken along a direction orthogonal to the vertical direction). The vertical length of the cuts 23 is made longer than the vertical length of the supporting section 12b, so that the upper end section of the lower punch 20a can project vertically above the upper end section of the container support 12 (supporting section 12b) and lift up the container placed on the container support 12.

As illustrated in FIG. 6, the upper end section of the lower punch 20a having the cross-shaped cuts 23 is formed such that a total of four quadrangular prisms are arranged, two lengthwise and two crosswise, with predetermined spacings therebetween. From the standpoint of applying ultrasonic vibration efficiently and evenly to the powder, it is preferable that all four quadrangular prisms constituting the upper end section of the lower punch 20a have the same size when viewing the horizontal cross-section thereof.

The area in which the lower punch 20a contacts the lower surface of the container 3 is preferably at least 50%, more preferably at least 80%, of the bottom area of a powder containing section of the container 3, from the standpoint of applying ultrasonic vibration to the powder in the container 3 efficiently via the lower punch 20a. The expression “bottom area of a powder containing section of the container” refers to the area of the bottom surface, on the inner side of the container, that supports the powder from below.

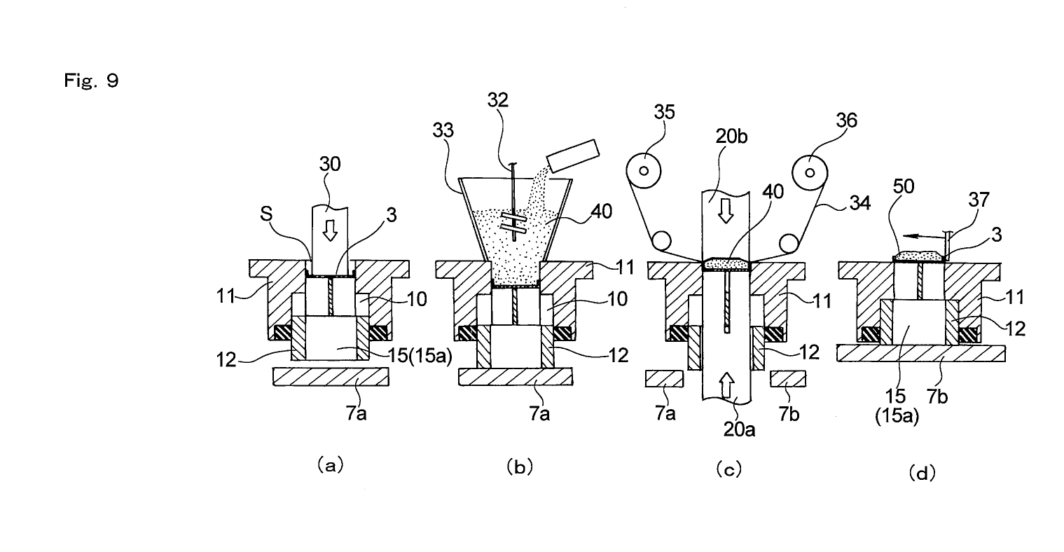

Note that the container 3 is a shallow, box-shaped container like a tray, as illustrated in FIGS. 2 and 9, and includes a flat bottom plate and walls surrounding the bottom plate and standing vertically upright therefrom. The “bottom area of a powder containing section of the container 3” thus refers to the inner-side area of the bottom plate. The container 3, when viewed from above in a direction orthogonal to the bottom plate (in the vertical direction) (i.e., in top view), has substantially the same shape as the top-view shape of the through hole 10 (see FIG. 4; a quadrangular shape with rounded corners) which defines the housing space S. It is preferable that the container 3 is formed to have such a size that, when it is housed in the housing space S, the clearance (space) between it and the inner wall surface of the through hole 10 defining the housing space S is around 50 to 150 μm. Note that the container 3 is not an element constituting the compacting device of the present embodiment and is independent from the compacting device.

In the present embodiment, it is preferable that, when the lower punch 20a and the upper punch 20b are moved vertically to confront one another, at least a portion of a contour line 20aa of a surface of the lower punch 20a confronting the upper punch 20b lies outside a contour line 20bb of a surface of the upper punch 20b confronting the lower punch 20a, as illustrated in FIG. 7. In other words, as illustrated in FIG. 7, it is preferable that, when the lower punch 20a and the upper punch 20b are made to confront one another, almost all of the contour line 20bb of the upper punch 20b (at least 90% of the entire length of the contour line 20bb) is surrounded by the contour line 20aa of the lower punch 20a. By designing the punches such that at least a portion of the contour line of the lower punch 20a at its confronting surface lies outside the contour line of the upper punch 20b at the time of making the upper punch 20b and the lower punch 20a confront one another, the container 3 is effectively prevented from getting damaged due to, for example, the shearing force of the punches and/or the ultrasonic vibration at the time of compressing the powder, together with the container 3, between the lower punch 20a and the upper punch 20b while applying ultrasonic vibration to the powder.

Preferably, the compacting device of the present embodiment further includes lifting/lowering means for vertically moving the container support 12 in the through hole 10 so that the housing space S can be made variable in capacity and thereby the amount of powder filled into the container 3 can be adjusted. For example, FIG. 8 illustrates capacity adjustment plates 7 as the lifting/lowering means. The capacity adjustment plates 7 are made of a rigid body, such as metal, and as illustrated in FIG. 8, the plates are provided on a surface 4a of the base member 4 opposing the turntable 2 which is supported by the base member 4 from below, and consist of projections that project from the opposing surface 4a toward the turntable 2. The projections (capacity adjustment plates 7) are disposed along the circumferential edge of the turntable 2, and consist of a semicircular pre-compression section 7a having a predetermined width and disposed continuously from the position indicated by symbol A in FIG. 1 up to the position of symbol D, and an arc-shaped post-compression section 7b having a predetermined width and disposed continuously from the position indicated by symbol D in FIG. 1 up to the position of symbol F. The pre-compression section 7a and the post-compression section 7b are discontinuous at two points—i.e., at the position of symbol D of FIG. 1 and at the position between symbol F and symbol A. The capacity adjustment plates 7 serve as guiderails for supporting, from below, the plurality of container supports 12 rotating in the circumferential direction of the turntable 2 and for guiding them to predetermined positions. The container supports 12 are placed on the upper surface of the projections.

The pre-compression section 7a is for supporting from below the container supports 12 from the timing immediately after the container 3 is fed onto the turntable 2 up until the timing immediately before compacting of the powder, and is disposed such that it can be moved vertically by a driving source (not illustrated). The height by which the pre-compression section 7a projects from the opposing surface 4a is made constant along its entire length. Actuating the not-illustrated driving source and moving the pre-compression section 7a vertically downward—i.e., reducing the height of the pre-compression section 7a projecting from the opposing surface 4a—will lower the container support 12 which is placed on the pre-compression section 7a, and thus, the capacity of the housing space S for the container 3 will be increased. This operation is performed to increase the capacity of the housing space S for the container 3 in cases where it is necessary to increase the amount of powder filled into the container 3. On the other hand, in cases where it is necessary to decrease the amount of powder filled into the container 3, the pre-compression section 7a is moved vertically upward to decrease the capacity of the housing space S, which is the reverse of the above-described operation.

The post-compression section 7b is for supporting the container supports 12 from the timing immediately after compressing the powder together with the container 3 up until the step where the container 3 containing the powder is discharged from the turntable 2. The height by which the post-compression section 7b projects from the opposing surface 4a increases along the direction of travel of the container supports 12 (i.e., along the turning direction of the turntable 2). In other words, the upper surface of the post-compression section 7b on which the container supports 12 are placed is inclined along its entire length, so that the container support 12 can move vertically upward as it travels from the position of symbol D to the position of symbol F of FIG. 1 and thereby the housing space S is decreased. In the present embodiment, the projection height of the post-compression section 7b is pre-adjusted so that the capacity of the housing space S becomes substantially zero at the midpoint between symbols E and F of FIG. 1, and thus, at the midpoint, the container 3 supported by the container support 12 is pushed up to be flush with the surface of the turntable 2.

Now, a method for compacting powder (method for manufacturing a solid powder compact) using the above-described compacting device of the present embodiment will be described below with reference to FIGS. 1 and 9. First, a not-illustrated driving source is actuated to turn the turntable 2 clockwise. Also, the conveyor 5 is actuated to convey a plurality of empty containers 3 near the turntable 2. Then, at the position of symbol A of FIG. 1, the container 3 is fed one-by-one with container placement means 30 into the housing space S of each compacting section 1 of the rotating turntable 2, as illustrated in FIG. 9(a). The container 3 is housed in the housing space S such that the outer surface of its bottom plate comes into contact with the upper end of the container support 12 (supporting section 12b). The container placement means 30 sucks or grips a container 3 on the conveyor 5, carries it above one of the compacting sections 1, and then moves into the housing space S of that compacting section 1 to press-in the container 3. Any known technique having such a mechanism can be used as appropriate for the present container placement means 30.

Next, at the position of symbol B of FIG. 1, powder 40 is filled into the container 3, as illustrated in FIG. 9(b). Filling of the powder 40 into the container 3 is done using a hopper 33 equipped with a mixing impeller 32. The powder 40 is supplied from the upper-end opening of the hopper 33, falls freely within the hopper 33 while being mixed by the mixing impeller 32, and then builds up on the inner surface of the bottom plate of the container 3 housed in the housing space S. As described above, the amount of powder 40 filled into the container 3 can be adjusted by adjusting the capacity of the housing space S, and the capacity of the housing space S can, in turn, be adjusted by vertically moving the pre-compression section 7a (the capacity adjustment plate 7) that supports from below the container support 12 defining the housing space S—i.e., by adjusting the height by which the pre-compression section 7a projects from the opposing surface 4a. The projection height of the pre-compression section 7a is adjusted in advance, prior to powder-filling, so as to set the capacity of the housing space S at the position of symbol B of FIG. 1 (or, the amount of powder filled into the container 3) to a predetermined value. The amount of powder 40 filled into the container 3 is determined depending on the type of powder 40, etc.

Then, at the position of symbol D of FIG. 1, the powder 40 is compressed, together with the container 3, by the lower punch 20a and the upper punch 20b, as illustrated in FIG. 9(c). In performing compression, the present embodiment first actuates the air cylinder 22b to lower the upper punch 20b from a predetermined standby position down to a predetermined pressing position and makes it wait there, and also actuates the ultrasonic vibration element 21b to cause ultrasonic vibration of the upper punch 20b. The device also actuates the ultrasonic vibration element 21a to cause ultrasonic vibration of the lower punch 20a, and in this state, actuates the air cylinder 22a to lift the lower punch 20a from a predetermined standby position and move it through the movement path 15. As illustrated in FIG. 8, there is no capacity adjustment plate 7 at the position of symbol D of FIG. 1, and therefore, the lower punch 20a can rise upward at the position of symbol D. The lower punch 20a is lifted up so that its upper end section can lift up the container 3 placed on the container support 12, to thereby press the powder 40 against the lower surface of the upper punch 20b on standby above. In this way, the powder 40 in the container 3 is compacted by the lower and upper punches 20a, 20b from below and above while being subjected to ultrasonic vibration, and is thus made into a compact 50. The powder 40 vibrates and becomes flowable by being subjected to ultrasound. Thus, a low-density, high-strength compact can be produced according to the present embodiment. The vibration conditions may be the same or different between the lower punch 20a and the upper punch 20b, but are generally the same. After compressing the powder 40 for a given period of time, the ultrasonic vibration is halted, and the air cylinder 22b is actuated again to lift the upper punch 20b back to its predetermined standby position and also the air cylinder 22a is actuated again to lower the lower punch 20a to retract it from the movement path 15 and return it back to its predetermined standby position.

Note that in the present embodiment, a sheet 34 made, for example, of cloth, paper, or a resinous film is provided between the upper punch 20b and the powder 40 at the time of pressing the powder 40 with the upper punch 20b, as illustrated in FIG. 9(c), with the aim of preventing attachment of powder to the upper punch or applying a pattern/design to the surface of the compact. The sheet 34 is paid out from a pay-out device 35 and wound up with a wind-up device 36 between the upper punch 20b and the die 11 (the turntable 2). As the upper punch 20b rises from the state shown in FIG. 9(c), the wind-up device 36 feeds the sheet 34 by a pitch corresponding to the width of the container 3 to renew the surface of the sheet in contact with the powder 40.

After compressing the powder 40 for a given period of time at the position of symbol D of FIG. 1, the container 3 containing the compact 50 is discharged from the turntable 2 using container-discharging means 37 at the midpoint between symbols E and F of FIG. 1, as illustrated in FIG. 9(d), to convey the container with the conveyor 6 to a predetermined position. As described above, downstream from the position of symbol D of FIG. 1 in the direction of travel of the container support 12, the container support 12 is supported from below by the post-compression section 7b (the capacity adjustment plate 7) whose projection height from the opposing surface 4a increases along the direction of travel. The projection height of the post-compression section 7b is pre-adjusted so that the capacity of the housing space S becomes substantially zero at the midpoint between symbols E and F of FIG. 1. Thus, at the midpoint between symbols E and F of FIG. 1, the surface of the upper end section of the container support 12 (the contacting section with the container 3) is substantially flush with the surface of the turntable 2, which allows the container-discharging means 37 to smoothly discharge the container 3 from the turntable 2. Any known technique having such a mechanism can be used as appropriate for the container-discharging means 37. According to the above processes, the intended compact 50 can be produced, contained in a container 3.

After the compact 50 contained in a container 3 is discharged as described above, the compacting section 1 returns to the position of symbol A of FIG. 1, and the above-described procedure is repeated. The capacity of the housing space S, which was substantially zero at the midpoint between symbols E and F of FIG. 1, is increased as the container support 12 travels between symbols F and A, where no capacity adjustment plate 7 exists, and thus moves downward, and at the position of symbol A, the housing space S will be in a state such that it can house a container 3.

In the above-described method for compacting powder (method for manufacturing a solid powder compact) using the compacting device of the present embodiment, the conditions of the ultrasonic vibration (ultrasound) applied to the powder 40 by the lower punch 20a and the upper punch 20b can be adjusted as appropriate depending on, for example, the components and formulation of the powder 40, and the particular usage of the intended compact 50. In cases where the compact 50 is, e.g., makeup foundation or a cheek rouge (blusher), the frequency of ultrasound at each of the lower punch 20a and the upper punch 20b is preferably 10 to 100 kHz, more preferably 15 to 30 kHz. Setting the frequencies within this range reduces the amount of attenuation of ultrasound within the powder 40, i.e., the medium, thus allowing the vibration to be transmitted deep into the powder 40.

The amplitude of ultrasound is preferably 5 to 100 μm, more preferably 10 to 80 μm, in cases where the compact 50 is, e.g., makeup foundation or a cheek rouge. Setting the amplitude within this range achieves sufficiently large vibration of particles, thus allowing uniform-density compacting in short periods of time.

The amplitude of ultrasound may be the same or different between the upper punch 20b and the lower punch 20a. In cases where a solid powder compact is produced by compacting powder 40 in a container 3 as in the powder compacting method of FIG. 9, it is preferable that the amplitude of ultrasound is made different between the upper punch 20b and the lower punch 20a from the standpoint of compacting powder 40 at a more uniform hardness. Particularly in cases where the container 3 is made of a material that can easily transmit ultrasonic vibration, such as metal, it is preferable that the ultrasound amplitude of the upper punch 20b is larger than that of the lower punch 20a.

The ultrasonic vibration application time period may be short and is not particularly critical in the present embodiment, and is preferably 0.1 to 5 seconds, more preferably 0.2 to 2.0 seconds. Depending on factors such as the melting point of the oil-based components and contents thereof, the weight and thickness of the powder 40, etc., applying ultrasonic vibration over extended time periods may lead to increased surface temperatures, which may lead to, e.g., material degradation, excessive hardness due to melting and hardening of oil-based components (which makes it difficult to take up powder when using the compact 50), an increase in amount of powder attaching to the punch, discoloration, etc. The ultrasonic vibration may be applied continuously or intermittently.

The pressure applied to the powder 40 by the lower punch 20a and the upper punch 20b can be determined as appropriate depending on the particular usage of the intended compact 50 and the composition thereof. Because ultrasonic vibration is applied by the lower punch 20a and the upper punch 20b from above and below the powder 40 in the present embodiment, the pressure applied to the powder 40 may be set to a smaller value compared to cases where ultrasonic vibration is applied to the powder 40 by only one of the punches. The pressure may be as low as preferably 0.1 to 2.5 MPa, more preferably 0.1 to 1.0 MPa.

The compacting device of the present embodiment has capacity adjustment plates 7 (pre-compression section 7a) serving as means for lifting/lowering the container support 12. Accordingly, the amount of powder filled into the container 3 can be adjusted depending on any type of powder. Such adjustment can prevent variations or reduction in quality of the compacts caused, e.g., by variations in quality and properties (e.g., bulk density) of the powder, thus allowing high-quality compacts to be produced continuously and efficiently. Furthermore, the compacting device of the present embodiment compacts powder while applying ultrasonic vibration thereto, and can therefore produce high-quality compacts having uniform density and hardly any defects, regardless of the type of powder used. Particularly in the present embodiment, the container support 12 for supporting the container 3 from below has a movement path 15 for the lower punch 20a, and this allows the ultrasonic-vibrating lower punch 20a to directly contact the lower surface of the container 3 placed on the container support 12. In this way, the lower punch 20a can apply ultrasonic vibration to the powder in the container 3 efficiently, thus allowing the above-described effects brought about by ultrasonic vibration to be achieved to the greatest extent possible.

The compacting device of the invention can be used for compacting various types of powder, such as powder cosmetic materials, in which case high-quality solid cosmetics (solid powder compacts) can be produced. The solid cosmetics may suitably be used in the form of makeup cosmetics, such as eye shadows, cheek rouges, and makeup foundations. The powder cosmetic material generally contains oil-based components and various pigments, such as body pigment, color pigment, and luster pigment, and may further contain, as appropriate, other additives such as surfactants, preservatives, antioxidants, perfumes, UV absorbers, humectants, and bactericides. Examples of body pigments include talc, mica, sericite, and kaoline. Examples of color pigments include colcothar, iron oxide yellow, and iron oxide black. Examples of luster pigments include pearl pigments. The content of pigments is generally around 5 to 90% by mass in the powder cosmetic material.

The oil-based components serve as binders for forming the solid shape of the solid powder cosmetic. The oil-based components are also important in terms of adherence of the makeup coating to the skin when the cosmetic is applied. Examples of oil-based components include hydrocarbons, various oils/fats, waxes, hydrogenated oils, ester oils, fatty acids, higher alcohols, silicone oils, fluorine-containing oils, lanolin derivatives, and oil-based gelling agents, irrespective of origin, e.g., whether it is animal, vegetable, or synthetic oil, and of properties/characteristics, e.g., whether it is solid, semi-solid, liquid, or volatile oil. The content of oil-based components is generally around 3 to 20% by mass in the powder cosmetic material.

Now, other embodiments of the present invention will be described. As regards the other embodiments described below, features/components different from the foregoing embodiment will primarily be described, and similar features/components are accompanied with the same symbols as above and are omitted from explanation. The explanation given in the foregoing embodiment applies as appropriate to features/components that are not described in particular below.

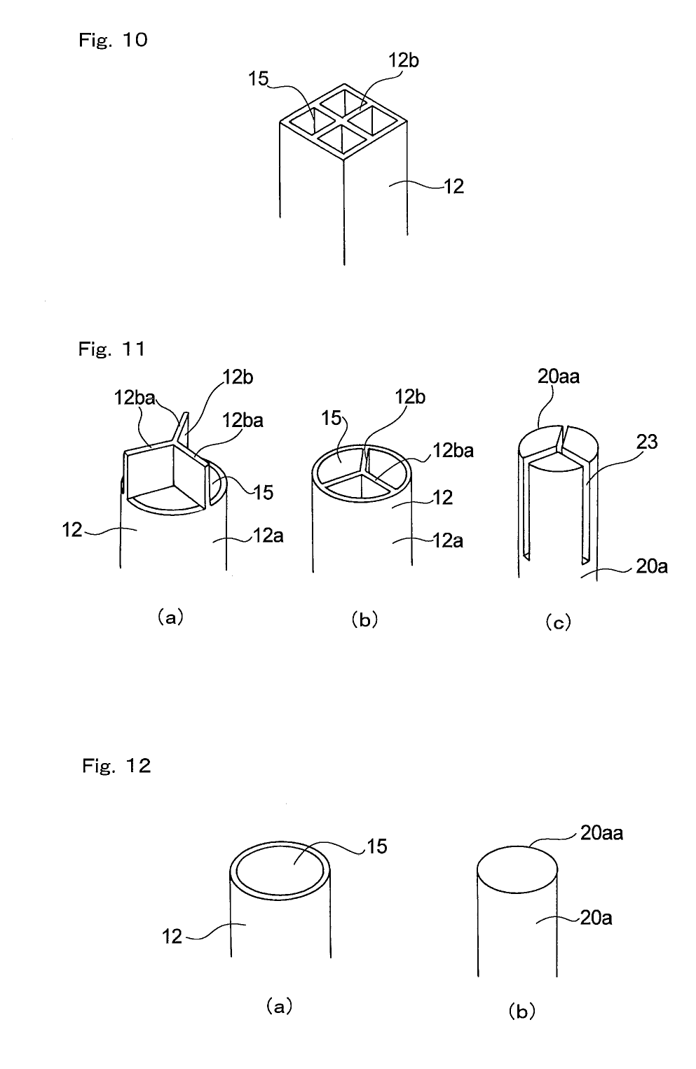

FIG. 10 illustrates another embodiment of a container support of the present invention. The container support 12 illustrated in FIG. 10 has the shape of a hollow quadrangular prism, and the hollow section is formed to include a supporting section 12b extending over a predetermined length from the upper end of the container support 12. The supporting section 12b has the shape of a cross when viewing a horizontal cross-section thereof (i.e., when viewing a cross-section taken along a direction orthogonal to the length direction of the container support 12 (i.e., the vertical direction)). The substantial difference between the container support of FIG. 5 and the container support of FIG. 10 is the presence of a frame surrounding the supporting section 12b which supports the container 3 from below. A container support having no frame as in FIG. 5 is preferable in terms that: (1) ultrasonic energy can be conveyed to all parts of the container 3; and (2) a portion of the contour line 20aa of the lower punch 20a lies outside the contour line 20bb of the upper punch 20b when the lower punch 20a and the upper punch 20b are made to confront one another, as described above.

FIG. 11(a) and FIG. 11(b) respectively illustrate other embodiments of the container support of the invention, and FIG. 11(c) illustrates a lower punch used in combination with the container support of FIG. 11(a) or FIG. 11(b). The container support 12 illustrated in FIG. 11(a) has a cylindrical base section 12a, and a supporting section 12b disposed on the base section 12a for supporting from below the container housed in the housing space S. The supporting section 12b consists of three plate members 12ba starting from the center of the cylindrical base section 12a and extending radially in three directions, when viewing the horizontal cross-section of the container support 12. These three plate members 12ba divide the cylindrical base section 12a into three equal parts consisting respectively of three arcs, when viewing a horizontal cross-section thereof. Next, the container support 12 illustrated in FIG. 11(b) has a hollow cylindrical shape, and the hollow section is formed to include a supporting section 12b extending over a predetermined length from the upper end of the container support 12. The supporting section 12b is formed having the same shape as the supporting section 12b of FIG. 11(a). The substantial difference between the container support of FIG. 11(a) and the container support of FIG. 11(b) is the presence of a frame surrounding the supporting section 12b. Meanwhile, the lower punch 20a illustrated in FIG. 11(c) has a cylindrical shape, and its upper end section (i.e., the front-end section as regards the direction in which the lower punch is inserted into the movement path 15) has cuts 23 of a predetermined length opened from the upper end and extending along the length direction of the lower punch 20a. These cuts 23, as illustrated in FIG. 11(c), are formed in a shape corresponding to the horizontal cross-sectional shape of the supporting section 12b illustrated in FIG. 11(a) or FIG. 11(b).

FIG. 12(a) illustrates another embodiment of a container support according to the invention, and FIG. 12(b) illustrates a lower punch used in combination with the container support of FIG. 12(a). The container support 12 of FIG. 12(a) has a hollow cylindrical shape, and the lower punch 20a of FIG. 12(b) has a cylindrical shape.

Although the present invention has been described above according to preferred embodiments thereof, the invention is not to be limited thereto. For example, the foregoing embodiments apply ultrasonic vibration to the powder using both the lower punch 20a and the upper punch 20b, but ultrasonic vibration may be applied from only the lower punch 20a or from only the upper punch 20b. It is, however, possible to produce compacts with higher quality by applying ultrasonic vibration to the powder from above and below as in the foregoing embodiments. Further, the compacting device of the invention is not limited to rotary, continuous compact production using a turntable as in the foregoing embodiments, but may also be applied, for example, to continuous compact production of other modes of operation (e.g., reciprocating mode).

### EXAMPLES

The present invention will now be described in further detail below according to Examples. The invention, however, is not to be limited thereto.

### Example 1

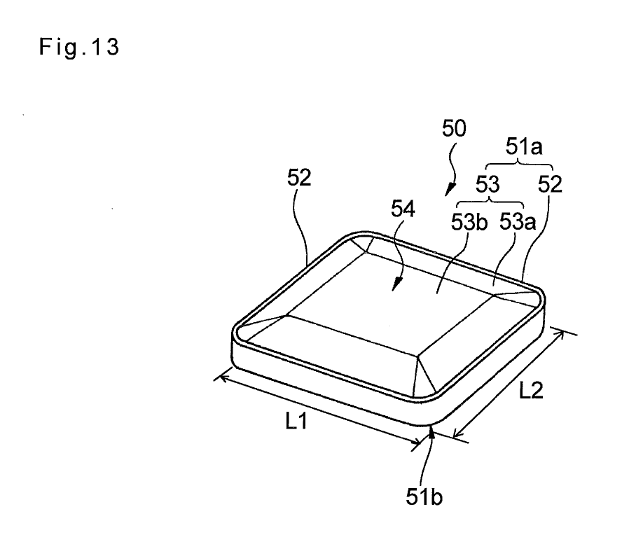

The compacting device structured as in FIG. 1 was used to perform the manufacturing steps illustrated in FIG. 9, to produce the compact 50 illustrated in FIG. 13. The compact 50 is a cheek rouge and has an upper surface 51a and an opposing lower surface 51b, as illustrated in FIG. 13. The compact 50 has a rectangular shape with rounded corners, having long sides L1 and short sides L2 in planar view. The lower surface 51b is formed as a flat, horizontal surface, whereas the upper surface 51a includes a flat, horizontal base surface 52 located along the circumferential edge, and a three-dimensional surface section 53 connected smoothly with the base surface 52. The three-dimensional surface section 53 includes inclined surfaces 53a and a top surface 53b parallel to the lower surface 51b. The portion above the base surface 52 constitutes a three-dimensional projection 54.

The composition and the manufacturing conditions of the compact 50 (cheek rouge) are as shown in Table 1 below. In Example 1, compacts 50 were manufactured continuously for eight consecutive days, 6.5 hours per day. The container support 12 of FIG. 5 was used for the manufacturing process. In Example 1, continuous compacting was possible, and the number of compacts 50 manufactured per minute was 13.4 (i.e., the manufacturing rate was 13.4 pieces/minute).

TABLE 1

| Composition of cheek rouge (compact): | % by mass | |
|---|---|---|
| (1) Fluorine-compound treated talc | 28.8% | |
| (average particle size: 7 μm) | | |
| (2) Fluorine-compound treated mica | 35.0% | |
| (average particle size: 10 μm) | | |
| (3) Fluorine-compound treated sericite | 8.0% | |
| (average particle size: 8 μm) | | |
| (4) Fluorine-compound treated spherical silicone resin | 2.0% | |
| (average particle size: 5 μm) | | |
| (5) Fluorine-compound treated titanium oxide | 0.5% | |
| (average particle size: 0.1 μm) | | |
| (6) Fluorine-compound treated iron oxide yellow | 0.3% | |
| (average particle size: 0.1 μm) | | |
| (7) Fluorine-compound treated iron oxide black | 0.1% | |
| (average particle size: 0.1 μm) | | |
| (8) Fluorine-compound treated Blue No. 404 | 1.2% | |
| (average particle size: 0.1 μm) | | |
| (9) Titanated mica (average particle size: 20 μm) | 10.0% | |
| (10) Colcothar-coated titanated mica | 2.0% | |
| (average particle size: 20 μm) | | |
| (11) Titanium oxide-coated glass powder | 4.0% | |
| (average particle size: 40 μm) | | |
| (12) Preservative | 0.1% | |
| (13) Liquid isoparaffin | 6.4% | |
| (14) Polyethylene wax (penetration number: 1) | 1.6% | |
| Manufacturing conditions: | Setting value | |
| (1) Application time of ultrasonic vibration | 1 | sec |
| (2) Time for which pressure was held after applying | 0.4 | sec |
| ultrasound | | |
| (3) Time for lowering lower pestle after holding pressure | 0.25 | sec |
| (4) Pressurizing force at time of compacting | 0.38 | MPa |
| (5) Ultrasound amplitude of upper pestle | 19.5 | μm |
| (6) Ultrasound amplitude of lower pestle | 15 | μm |
| (7) Ultrasound frequency | 20 | KHz |

The number of cheek rouges that can serve as final products (i.e., the “number of products”) can be found by subtracting the number of poor outer-appearance products from the total number of cheek rouges compacted by the compacting device (i.e., the “total compacting number”). Herein, a “poor outer-appearance product” refers to a product found to have defects, such as scratches, cracks, chips, dents, or unevenness in color, when the outer appearance of each and every compact is inspected at the exit of the compacting device. The yield (%) can be found from the “number of products” and the “total compacting number” (that is, yield (%)=“number of products”/“total compacting number”×100). In Example 1, the average yield for eight days was 96%. Further, the variation in yield from day to day was extremely small (standard deviation: 1.18%) even though the material lots were changed during continuous production, showing that Example 1 could manufacture cheek rouges stably.

### Comparative Example 1

Compacts 50 (cheek rouges) as illustrated in FIG. 13 were manufactured according to the same conditions as in Example 1, except that no container support 12 was used. Because no container support 12 was used in Comparative Example 1, continuous compacting was not possible, and thus the number of compacts 50 manufactured per minute was 1 (i.e., the manufacturing rate was 1 piece/minute).

### Comparative Example 2

Compacts 50 (cheek rouges) as illustrated in FIG. 13 were manufactured according to the same conditions as in Example 1, except that a container support having no movement path 15 for the lower punch 20a (see FIG. 5) was used in place of the container support 12. The cheek rouges manufactured according to Comparative Example 2 were “poor outer-appearance products”, exhibiting defects such as cracks, chips, and unevenness in hardness, and could not serve as final products. Further, in Comparative Example 2, abrasion occurred in the compacting device, and continuous compacting was not possible for extended periods of time.

Evaluation:

The surface hardness, weight, total height, and drop strength of respective cheek rouges (compacts 50) of Example 1 and Comparative Example 1 sampled immediately after compacting with the compacting device were measured at predetermined time intervals according to the methods described below. For each examined item, the maximum value, the minimum value, the average, and the difference between the maximum and minimum of all measurement values obtained through eight days of measurement are shown in Table 2 below.

Surface Hardness:

The compact surface hardness was measured using an “Asker JAL” durometer at two-hour intervals from immediately after starting production. Referring to the compact 50 illustrated in FIG. 13, the points for measuring surface hardness are located on the top surface 53b on a single straight line that divides each of the opposing short sides L2 in half and 5 mm away from each short side, which means that there are two measurement points on a single compact 50. The needle of the Asker JAL durometer was injected into each measurement point from above the compact, and the surface hardness was measured according to ordinary procedures. Three pieces of compacts were used as samples in a single measurement. The larger the surface hardness, the harder the surface of the compact; the smaller, the softer. The standard of surface hardness is such that the compact surface hardness indicates “30” in cases where an appropriate amount of powder can be scraped off when the compact surface is brushed with a cheek brush.

Weight:

The compact weight was measured at two-hour intervals from immediately after starting production. Three pieces of compacts were used as samples in a single measurement.

Total Height:

The total height of a compact (the height from the lower surface 51b to the top surface 53b in the compact 50 of FIG. 13) was measured at two-hour intervals from immediately after starting production. Three pieces of compacts were used as samples in a single measurement, and the height of each compact was measured in a single area.

Drop Strength:

The drop strength of a compact was measured by: holding a compact 50 at a height of 30 cm above a stainless-steel plate such that the lower surface 51b of the compact 50 is substantially parallel to the stainless-steel plate; and from this state, allowing the compact 50 to fall freely toward the stainless-steel plate. This dropping process was repeated until a defect, such as a crack or chip, appeared in the compact, and the number of times of dropping processes required for the compact to crack, chip, etc., was recorded. It can be evaluated that, the larger the number of times of dropping processes, the higher the drop strength is and the more uniform the compact is in density, which means that the compact has higher quality. The drop strength was measured at two-hour intervals from immediately after starting production. Three pieces of compacts were used as samples in a single measurement.

TABLE 2

| | | Manufactur- | | | | |
|---|---|---|---|---|---|---|
| | | ing rate | Surface | Weight | Total height | Drop strength |
| | | (pieces/min) | hardness | (g) | (mm) | (times) |
| Example 1 | Average | 13.4 | 30.03 | 5.15 | 6.00 | 20 |
| | Maximum | — | 33.00 | 5.29 | 6.10 | 20 |
| | Minimum | — | 27.00 | 4.89 | 5.90 | 20 |
| | Range | — | 6.00 | 0.40 | 0.20 | 0 |

| | | | | | |
|---|---|---|---|---|---|
| Comparative Example 1 | 1 | 31.00 | 4.80 | 5.73 | 20 |

The results of Table 2 show that Example 1 is capable of continuously manufacturing, stably and without variation, compacts (cheek rouges) being equal in surface hardness, weight, total height, and drop strength to Comparative Example 1 which does not allow continuous compacting. Particularly, from the result that the drop strength of the compacts obtained in Example 1 is 20 times or more, it is inferred that the compacts of Example 1 have uniform density. The above examination results and results regarding the yield prove that Example 1, which manufactures cheek rouges according to the manufacturing steps illustrated in FIG. 9 using the compacting device structured as in FIG. 1, can stably and efficiently produce high-quality compacts having uniform density and hardly any defects.

### REFERENCE SIGNS LIST

1: Compacting sections;
2: Turntable;
3: Container;
4: Base member;
4a: Surface of base member opposing turntable;
7: Capacity adjustment plate (lifting/lowering means);
7a: Pre-compression section;
7b: Post-compression section;
10: Through hole;
11: Die;
12: Container support;
12a: Base section;
12b: Supporting section;
14: Resinous section;
15: Movement path;
20a: Lower punch;
20b: Upper punch;
40: Powder;
50: Compact;
S: Housing space for container.

1. A powder compacting device for compacting powder contained in a tray-like container while applying ultrasonic vibration to the powder, comprising:
a die having a through hole extending in a vertical direction;
a container support inserted into the through hole vertically from below, disposed to be vertically movable in the through hole, and supporting the container from below while being in contact with a portion of a lower surface of the container, the container support and the through hole defining a housing space for the container;
a lower punch for applying ultrasonic vibration to the powder in the container, the lower punch being disposed to be vertically movable below the container supported by the container support; and
an upper punch disposed to be vertically movable in a position opposing the lower punch across the container, the upper punch and the lower punch being capable of compressing the powder together with the container,
wherein the container support has a movement path for the lower punch to move in, the movement path being formed along the entire vertical length of the container support, and
wherein the lower punch is provided in such a manner that it can move through the movement path and come into contact with portions of the lower surface of the container other than the portion thereof contacted by the container support to support the container.

2. The powder compacting device according to claim 1, wherein an area in which the lower punch contacts the lower surface of the container is at least 50% of a bottom area of a powder containing section of the container.

3. The powder compacting device according to claim 1, wherein, when the lower punch and the upper punch are moved vertically to confront one another, at least a portion of a contour line of a surface of the lower punch confronting the upper punch lies outside a contour line of a surface of the upper punch confronting the lower punch.

4. The powder compacting device according to claim 1, wherein contacting sections of the container support in contact with the container are arranged in a radial pattern when viewing a horizontal cross-section of the contacting sections.

5. The powder compacting device according to claim 1, wherein a wall surface of the through hole defining the housing space for the container is formed containing resin.

6. The powder compacting device according to claim 1, further comprising lifting/lowering means for vertically moving the container support in the through hole so that the housing space can be made variable in capacity and thereby an amount of the powder filled into the container can be adjusted.

7. A method for manufacturing a solid powder compact, comprising using the powder compacting device according to claim 1.
